(19) United States
(12) Patent Application Publication
(10) Pub. No.: US 2007/0220791 A1
(43) Pub. Date: Sep. 27, 2007

(54) Mock X-ray/ultraviolet machine

(76) Inventors: Samuel L. Chapman, Port Huron, MI (US); Samuel C. Johnson, Houston, TX (US)

Correspondence Address: CHRISTOPHER JOHN RUDY, 209 HURON AVENUE, SUITE 8, PORT HURON, MI, 48060, US

(21) Appl. No.: 11/803,799

(22) Filed: May 16, 2007

Related U.S. Application Data
(60) Provisional application No. 60/876,781, filed on Dec. 23, 2006.

(51) Int. Cl. G02B 27/02

(52) U.S. Cl. 40/367

(57) ABSTRACT

Device with light can be employed to view an image otherwise hidden to the eye. The hidden image can be masked with another image that is visible to the eye without aid of the device. A display card can be employed to provide masking and hidden images.

This claims benefits under 35 USC 119(e) of application No. US60/876,781 filed on Dec. 23, 2006 A.D., the specification of which is incorporated herein by reference.

### FIELD AND PURVIEW OF THE INVENTION

The invention concerns a device that, through the use of light, can be employed to view an image otherwise hidden to the eye. The hidden image can be masked with another image that is visible to the eye. The invention also concerns use of the device.

### BACKGROUND TO THE INVENTION

Various art is known relating to signage and image display. See, e.g., the following U.S. patents:

U.S. Pat. No. 1,881,417 to Hodgkin. This discloses an advertising device and method of making the same.

U.S. Pat. No. 2,147,033 to Hays. This discloses a sign.

U.S. Pat. No. 3,658,365 to Greubel. This discloses a book shaped educational amusement device.

U.S. Pat. No. 3,726,702 to Ciskowski. This discloses a method for making shaded artwork.

U.S. Pat. No. 4,307,899 to Hoppe. This discloses an identification card with hallmarks adapted to be inspected by transmitted and incident light and a process for the production thereof.

U.S. Pat. No. 4,747,223 to Borda. This discloses a mirrored communication system.

U.S. Pat. No. 5,589,980 to Bass et al. This discloses a three dimensional optical viewing system.

U.S. Pat. No. 5,956,180 to Bass et al. This discloses an optical viewing system for asynchronous overlaid images.

U.S. Pat. No. 5,991,057 to Goldstein. This discloses image transformation of a picture by using a superimposed hologram.

U.S. Pat. No. 6,212,805 to Hill. This discloses a panel with light permeable images.

U.S. Pat. No. 6,502,339 to Shapiro. This discloses a shadow display device.

U.S. Pat. No. 6,517,407 to Peters. This discloses a three-dimensional interactive book.

U.S. Pat. No. 6,722,066 to Cheung. This discloses single and multiple illuminated images.

U.S. Pat. No. 6,799,515 to Lynn et al. This discloses a luminous double faced picture display.

U.S. Pat. No. 6,976,915 to Baker et al. This discloses a gaming device display with simulated halftones.

U.S. Pat. No. 7,040,993 to Lovitt. This discloses an amusement device with concealed images.

It would be desirable to improve upon or supply an alternative to the art.

### A FULL DISCLOSURE OF THE INVENTION

In general, the present invention provides a device that, through the use of light, can be employed to view an image otherwise hidden to the eye. The hidden image can be masked with another image that is visible to the eye. Provided also is use of the device.

The invention is a useful amusement or educational device.

Significantly, by the invention, the art is improved in kind. More particularly, the invention provides a simple, relatively safe device, which not only serves as a surprising amusement but arouses curiosity and can engender a desire to learn, and aid in learning, especially with children. The device is inexpensive to make and simple to operate.

Numerous further advantages attend the invention.

The drawings form part of the specification hereof. With respect to the drawings, which are not necessarily drawn to scale, the following is briefly noted:

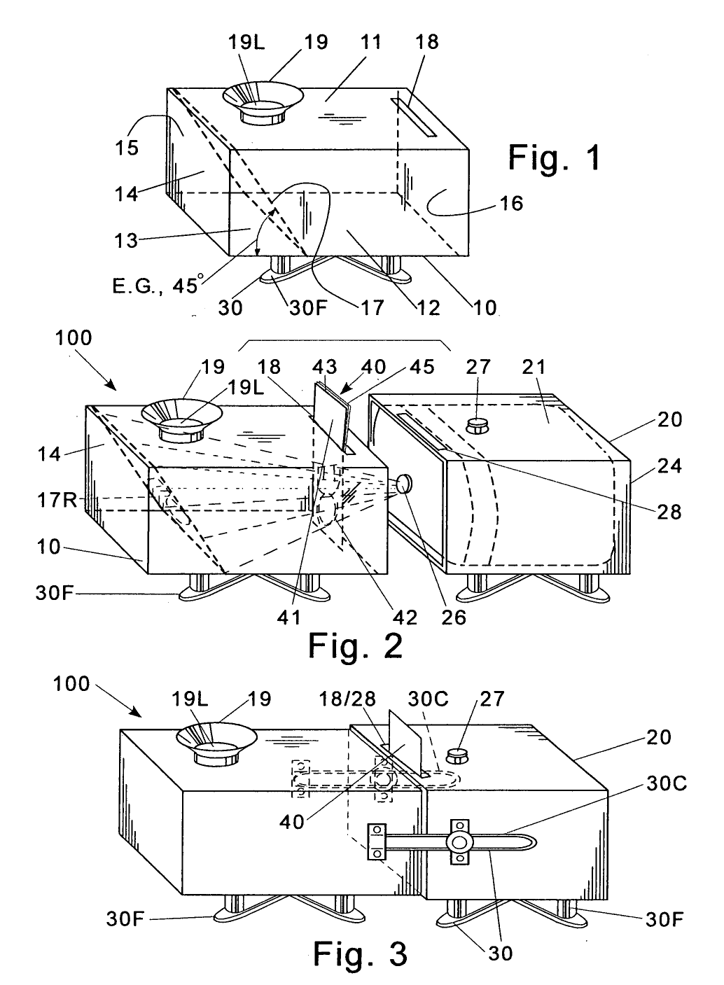

FIG. 1 is a perspective plan view of a first housing member for a device hereof.

FIG. 2 is a perspective plan view of the device with the first housing member and a second housing member for use in conjunction therewith.

FIG. 3 is a perspective plan view of the device of FIGS. 1 and 2, assembled.

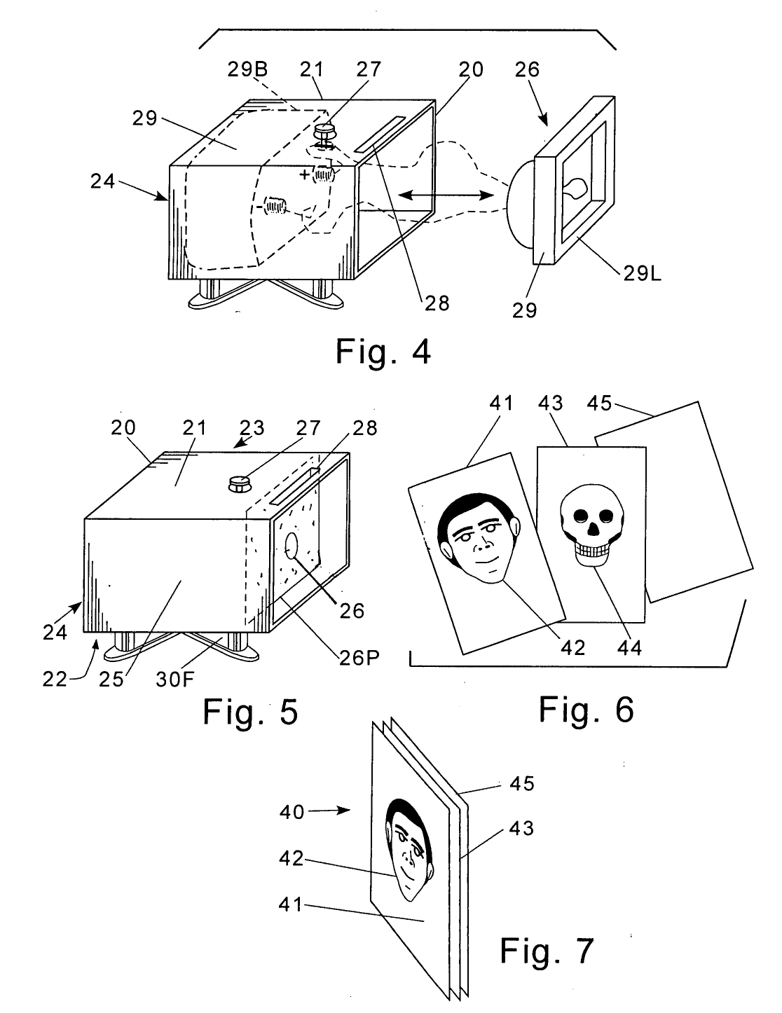

FIG. 4 is a perspective plan view of the second housing member in FIG. 2.

FIG. 5 is a perspective view of the second housing member of FIG. 4.

FIG. 6 is an exploded view of a display card for the device of FIGS. 1-5.

FIG. 7 is a perspective view of an arrangement of elements of the card of FIG. 6.

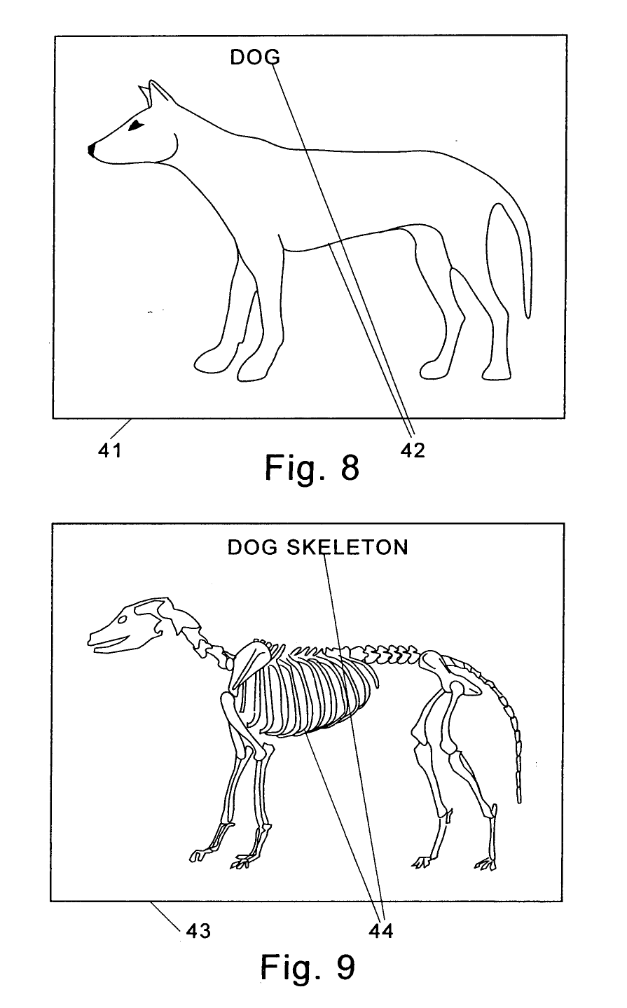

FIG. 8 is a front view of a masking image in another display card.

FIG. 9 is a front view of a suitable hidden image for the masking image of FIG. 8.

The invention can be further understood by the detail set forth below. This, just as with the foregoing, is to be read in an illustrative and not necessarily limiting sense.

With respect to the drawings, device 100 can be embodied as a mock X-ray/ultraviolet machine. The device 100 has a housing, which can be of any suitable configuration, for example, configured to have first housing member 10 and second housing member 20, each of which has a substantially rectangular block like shape, and which may be affixed and supported by accessory elements 30 and separated for ready maintenance. Display card 40 can be employed to provide masking and hidden images. The device 100 employs light visible to the naked eye.

The first housing member 10 can be hollow, or otherwise include materials through which light can pass in salient regions of its interior portion, and can have opaque top 11, opaque bottom 12, opaque right hand side wall 13, opaque front wall 14, and opaque left hand side wall 15. The opacity, although not required, may add to the mystery and aesthetic appeal of the device 100. A rear portion of the first housing member 10 can be open or have light-transmissive panel 16 installed. Inside the first housing member 10 can be light-reflective mirror 17, from which can be reflected revealed image 17R with insertion of the display card 40 into an opening, card slot 18, which revealed image 17R can be viewed, say, through an orifice or port for viewer 19, which may include magnifying lens 19L.

The second housing member 20 also can be hollow, or otherwise include materials through which light can pass in salient regions of its interior portion, and can have opaque top 21, opaque bottom 22, opaque right hand side wall 23, opaque rear wall 24, and opaque left hand side wall 25. Again, the opacity, although not required, may add to the mystery and aesthetic appeal of the device 100. A front-facing portion of the second housing member 20 can have light source 26, the light of which may pass through an open interior end of the second housing member 20 or through light-transmissive panel 26P, which may have white filter paper or other material to cause a luminescent, light-scattering effect, to communicate with the interior of the first housing member 10. Light source control 27 such as an on-off or dimmer switch can be provided. Opening, card slit 28, which may overlap the card slot 18 of the first housing member 10 when the first and second housings 10, 20 are connected, may be provided. Light supply elements 29 may include battery 29B, for example, a six-volt battery, and reflector lens 29L.

Any suitable accessory elements 30 may be provided, for example, for affixing and supporting the first and second housing members 10, 20. Thus, the first and second housing members 10, 20 may be connected through connectors 30C such as any suitable fasteners, and may be supported by feet 30F.

The display card 40 may be a simple composite or laminate sheet contrivance, which can include cover sheet 41, say, of paper, with masking image 42 provided thereon, which is visible to the naked eye without the aid of the device 100, and surprise feature sheet 43, say, of paper, with hidden image 44 provided thereon. The masking image is made substantially or entirely with an ink or another suitable substance, which does not substantially interfere with the transmission of light from the light source 26. The hidden image, however, is made with an ink or another suitable substance, for example, typewriter correction fluid, which does substantially interfere with the transmission of light from the light source 26; thus, it can be an opaque ink, and the hidden image 44, when employed with the operating device 100, becomes the revealed image. Optional rear sheet 45 may be provided, which may be blank or which may have thereon another masking image that may be an image such as that corresponding to the masking image 42 or information such as educational or identifying information provided with light-transmissive ink or even provided with opaque ink to be viewed along with the hidden image that is revealed as the revealed image 17R. The rear sheet 45 can be a white filter paper or the like to cause a luminescent effect. Of course, one could provide a masking image and a hidden image on the same display card 40, which may be made of one sheet. The hidden image 44 may include an interior feature of the masking image 42, for example, a skeletal system or part thereof for a vertebrate; a circulatory, digestive, muscular or nervous system or part thereof for an animal or human; and so forth. The hidden image 44 can also be the solution to a question proposed by the masking image 42, for example, in geography, language, mathematics or religion, and so forth. The masking image 42 can be unseen when the hidden image 44 is revealed in the device 100.

### CONCLUSION TO THE INVENTION

The present invention is thus provided. Various feature(s), part(s), step(s), subcombination(s) and/or combination(s) may be employed with or without reference to other feature(s), part(s), step(s), subcombination(s) and/or combination(s) in the practice of the invention, and numerous adaptations and modifications can be effected within its spirit, the literal claim scope of which is particularly pointed out as follows:

We claim:

1. A device useful for viewing an image, which comprises a housing, through an interior portion of which light can pass; a light source for providing a light beam in said interior portion; an opening in the housing into which a display card can be inserted; a viewing port through which an image from the display card can be viewed; and a reflective mirror inside the housing such that the mirror can reflect the light beam and the image from the display card to the viewing port.

2. The device of claim 1, wherein the housing includes opaque outside surfaces.

3. The device of claim 1, further comprising the display card, which includes a masking image transmissive of the light beam and viewable with the naked eye without the aid of the device but not seen when inserted into the opening in the housing into which the display card can be viewed, and a hidden image substantially opaque to the light beam and revealable by passing the light beam through the hidden image.

4. The device of claim 2, further comprising the display card, which includes a masking image transmissive of the light beam and viewable with the naked eye without the aid of the device but not seen when inserted into the opening in the housing into which the display card can be viewed, and a hidden image substantially opaque to the light beam and revealable by passing the light beam through the hidden image.

5. A method for displaying an image, which comprises providing a device having a housing through an interior portion of which light can pass, a light source for providing a light beam in the interior of the housing, an opening in the housing into which a display card can be inserted, and a viewing port; providing the display card, wherein the display card includes a masking image transmissive of the light beam and viewable with the naked eye without the aid of the device but not seen when inserted into the opening in the housing into which the display card can be viewed, and a hidden image substantially opaque to the light beam and revealable by passing the light beam through the hidden image; activating the light source; inserting the display card into the opening; and, through the viewing port, viewing the hidden image revealed by the light beam.

6. The method of claim 5, wherein the hidden image includes an interior feature of the masking image, or a solution to a question posed by the masking image.

7. The method of claim 5, wherein the interior feature includes bones.
